(19) United States
(12) Patent Application Publication
(10) Pub. No.: US 2026/0188988 A1
(43) Pub. Date: Jul. 2, 2026

(54) FURRED WALL BOX

(71) Applicant: Thomas J. Gretz, DELRAY BEACH, FL (US)

(72) Inventor: Thomas J. Gretz, DELRAY BEACH, FL (US)

(73) Assignee: Arlington Industries, Inc., Scranton, PA (US)

(21) Appl. No.: 19/419,063

(22) Filed: Dec. 14, 2025

Related U.S. Application Data
(60) Provisional application No. 63/706,934, filed on Oct. 14, 2024.

(51) Int. Cl. H02G 3/08; H02G 3/10

(52) U.S. Cl. CPC H02G 3/081; H02G 3/10

(57) ABSTRACT

A furred wall box assembly including a back plate, a top plate, and a cover plate. The back plate includes a base wall extending forward from its periphery. A plurality of knockouts are provided in the base wall. An outer wall extends outward from the front plate. Apertures in the front plate are aligned with and bosses in the back plate and fasteners used to secure the front plate to the back plate to form an outlet box within the joined front plate and back plate. A first flange is used to mount the box to a furring strip and a second flange is used to mount the box directly to the wall. A cover plate is mounted to the outer wall to complete the box assembly. The furred wall box assembly is especially useful for mounting an outlet box on a concrete masonry surface.

This application claims priority from U.S. Provisional Patent Application No. 63/706,934 filed on Oct. 14, 2024.

### FIELD OF THE INVENTION

This invention relates to boxes for mounting electrical components on walls and, specifically, to a Field Service (FS) box that may be rapidly mounted to a concrete wall without breaking concrete masonry walls.

### BACKGROUND OF THE INVENTION

Mounting an outlet box on a concrete wall typically requires breaking the walls of one or more concrete masonry units (CMU) to accommodate portions of the outlet box. This can be a very time and labor-intensive procedure as it involves physically breaking the walls of the CMU and resealing the resultant opening or openings surrounding the FS box.

Accordingly, there is a need for an FS box that includes features to enable faster and less labor-intensive mounting to a wall constructed of concrete masonry units.

### BRIEF SUMMARY OF THE INVENTION

The invention is a furred wall box for mounting electrical outlets on a wall constructed of concrete masonry units, such as the foundation of many buildings. The furred wall box comprises a box and cover assembly including a back plate, a top plate, and a cover plate. The back plate includes a front surface and a rear surface. A base wall extends forward from the back plate. A plurality of knockouts are provided in the base wall. A first flange extends outward from the front edge of the back plate and a second flange extends from the rear surface of the back plate. A top wall extends from the top plate. Apertures in the top plate are aligned axially with bosses in the back plate and fasteners secure the front plate to the back plate to create an outlet box assembly. Either flange can be used to mount the outlet box assembly to a wall. The first flange can be used to mount the box to a furring strip on a furred wall and the second flange can be used to mount the box directly to a CMU wall. The cover plate is mounted to the outlet box assembly to complete the installation. The furred wall box eliminates the need for breaking and resealing CMU walls in order to install an outlet box.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a front elevation view of a single-gang furred wall box assembly according to the invention.

FIG. 2 is a side view of the single-gang furred wall box assembly as viewed from the right side of FIG. 1.

FIG. 3 is an end view of the single-gang furred wall box assembly.

FIG. 4 is a top perspective view of the single-gang furred wall box assembly.

FIG. 5 is an exploded perspective view of the single-gang furred wall box assembly, with the cover plate exploded away from the top and back plates.

FIG. 6 is a front elevation view of a back plate and top plate assembled together to form the lower portion of a single-gang furred wall box assembly.

FIG. 7 is a side view of a back plate and top plate assembled together to form the lower portion of a single-gang furred wall box assembly.

FIG. 8 is an end view of a back plate and top plate assembled together to form the lower portion of a single-gang furred wall box assembly.

FIG. 9 is a perspective view of a back plate and top plate assembled together to form the lower portion of a single-gang furred wall box assembly.

FIG. 10 is a perspective view of the first side of a top plate of a single-gang box.

FIG. 11 is a perspective view of the second side of a top plate of a single-gang box.

FIG. 12 is a top perspective view of a back plate and top plate assembled together to form the lower portion of a two-gang furred wall box assembly, which is a second embodiment according to the invention.

FIG. 13 is a front elevation view of the lower portion of the two-gang furred wall box assembly of FIG. 12.

FIG. 14 is a side view of the two-gang furred wall box assembly as viewed from the right side of FIG. 12.

FIG. 15 is an end view of the two-gang furred wall box assembly shown in FIG. 12.

FIG. 16 is a second drawing reflecting a top perspective view of a back plate and top plate assembled together to form the lower portion of a two-gang furred wall box assembly.

FIG. 17 is a perspective view of the back plate of a single-gang furred wall box.

FIG. 18 is a sectional view of the back plate of the single-gang furred wall box.

FIG. 19 is a perspective view of the first side of a top plate of a two-gang box.

FIG. 20 is a perspective view of the second side of a top plate of a two-gang box.

FIG. 21 is an exploded view of single-gang furred wall box assembly which includes an electrical receptacle and mounting hardware.

FIG. 22 is a perspective view illustrating mounting a single-gang furred wall box assembly using either the first flange to a furring strip on a furred wall or the second flange to mount directly to a CMU wall and depicting an electrical receptacle mounted in the electrical box.

FIG. 23 is a perspective view of the single-gang furred wall box assembly secured to a furred wall with drywall surrounding the mounted box.

FIG. 24 is a front view of another embodiment of single-gang furred wall box assembly illustrating the use of two ringed bosses added to the back wall of the back plate.

FIG. 25 is a front elevation view of a two-gang furred wall box assembly illustrating the use of two ringed bosses added to the back wall of the back plate.

### DETAILED DESCRIPTION OF THE INVENTION

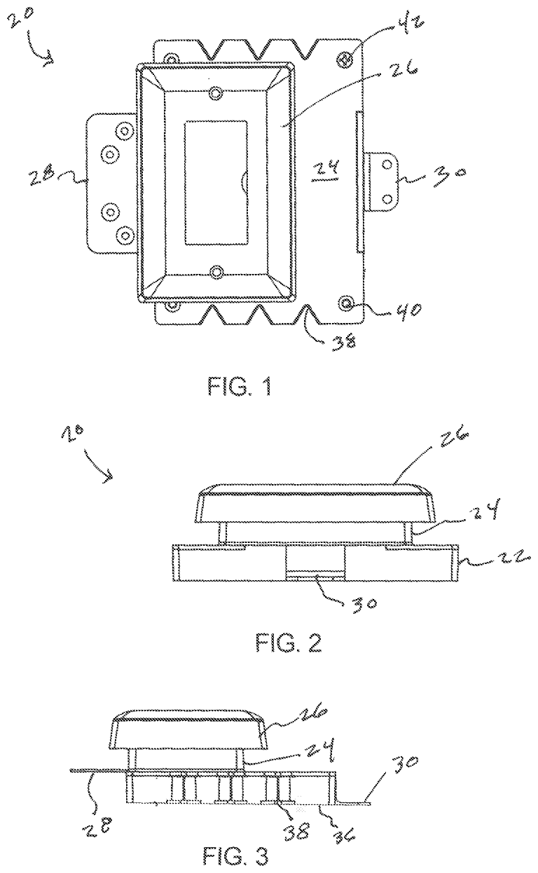

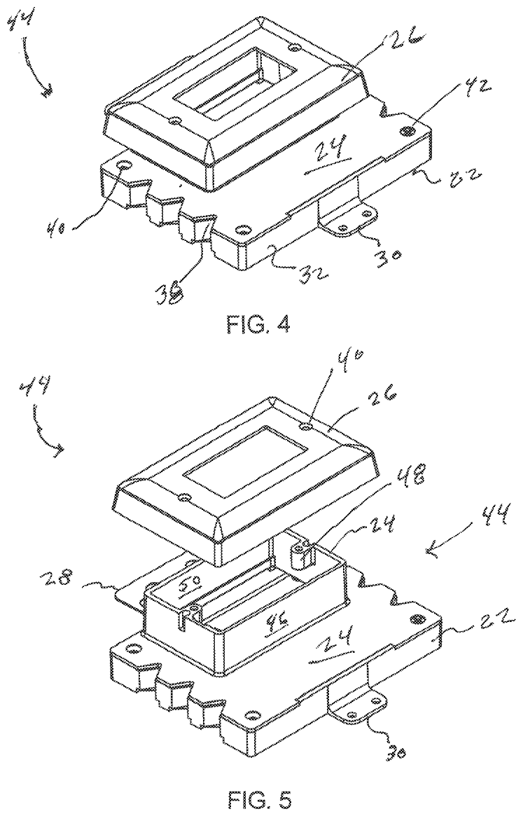

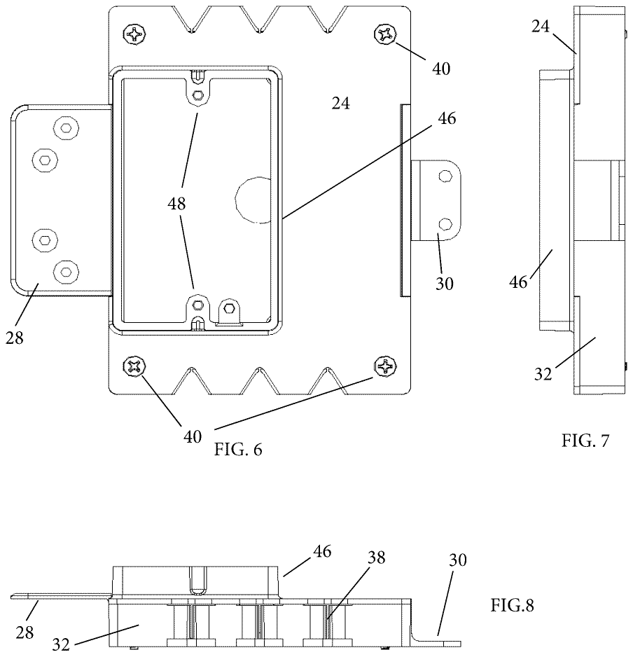

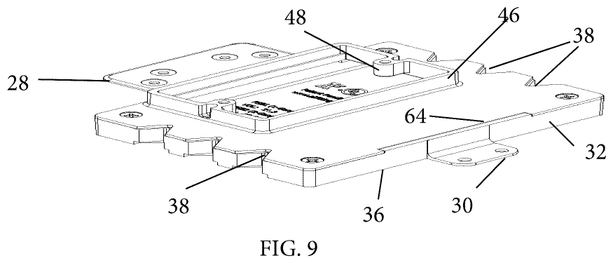

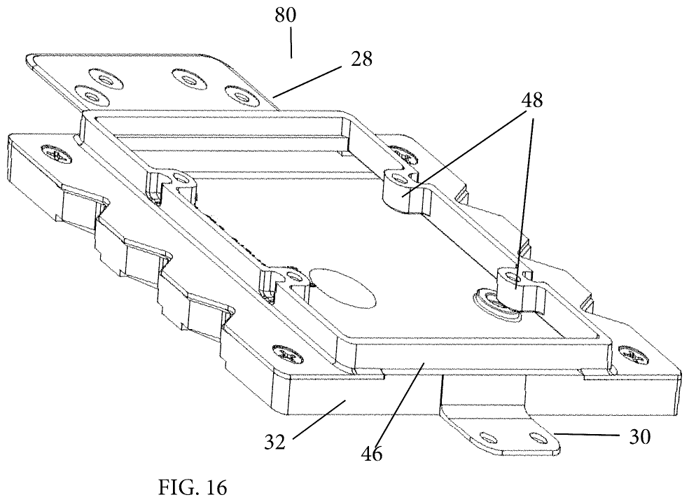

With reference to FIGS. 1-23, the current invention is a furred wall box, which can be either a single-gang furred wall box or a two-gang furred wall box.

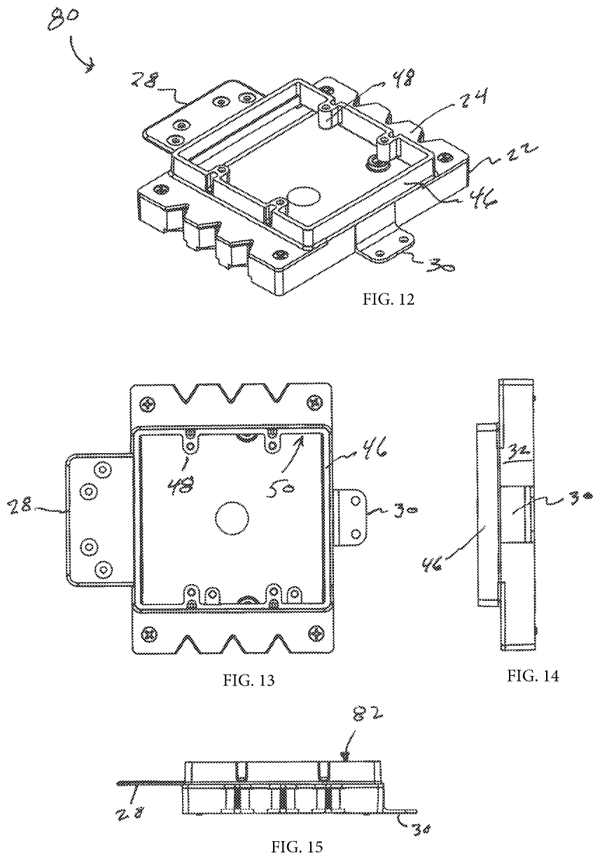

The first embodiment is single-gang furred wall box shown in FIGS. 1-11. Referring to FIGS. 1-5, the single-gang furred wall box assembly 20 includes a back plate 22, a top plate 24, and a cover plate 26. The second embodiment, illustrated in FIGS. 12-16 is a two-gang furred wall box. The two-gang furred wall box, designed to accommodate two electrical devices or receptacles, also includes a back plate 22, a top plate 24, and a cover plate 26.

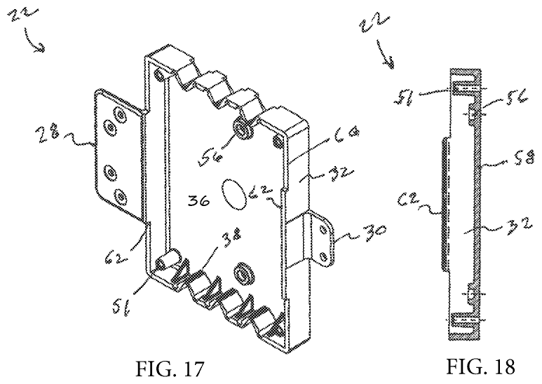

The back plate 22, shown as part of the single-gang assembly in FIGS. 1-3 and as an individual component in FIGS. 17 and 18, includes a rear surface 36 and a base wall 32 having a planar top section or surface 60. Wall extensions 62 extend outward from the base wall along a portion of the top surface 60 on two sides of the back plate 22. Back plate includes one or two flanges 28, 30 extending outward from the plate. As shown, for example, in FIGS. 3 and 17, a first flange 28 extends outward from the front edge of the wall extension 62 and a second flange 30 is flush with the rear surface 36 of the back plate 22. A plurality of knockouts 38 are provided in the base wall 32.

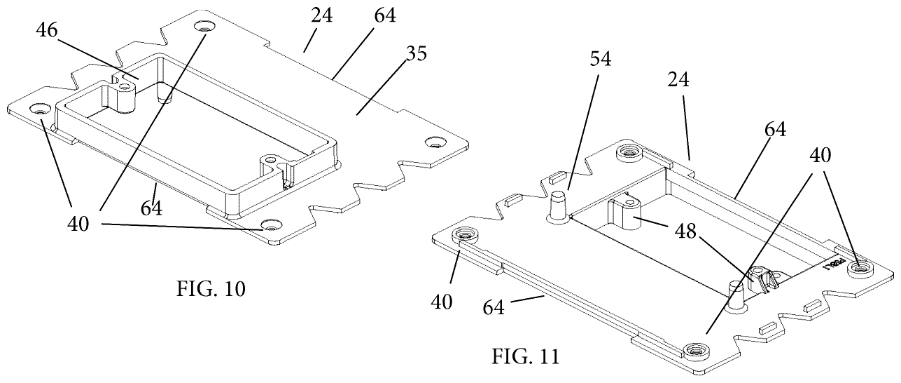

Referring to FIGS. 10 and 11, top plate 24 is comprised of a plate surface 35 and a top wall 46. Top wall 46 extends from one side of the top plate 24. One or more bosses 48 extend from the inner surface 50 of the top wall 46 for securing an electrical receptacle to the electrical box assembly 44. Apertures 40 in the top plate 24 align axially with bosses 51 on the back plate 22 and fasteners 42 secure the top plate to the back plate to form the outlet box assembly 44.

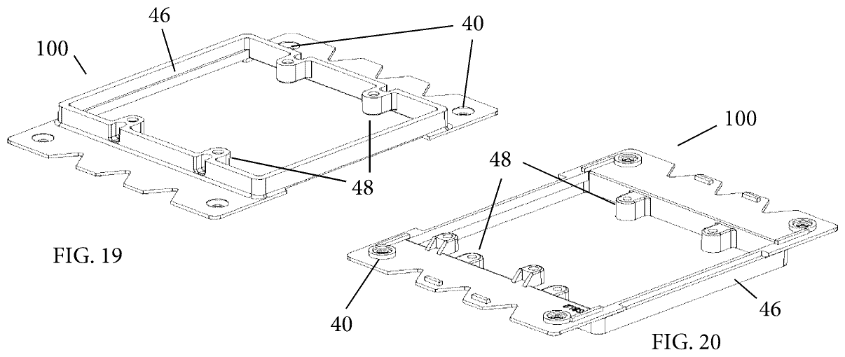

An alignment feature includes posts 54 on the top plate 24 and corresponding sockets 56 on the rear wall 36 of the back plate 22. Further, top plate has a corresponding notch 64 along each of its sides 66. When assembling the top plate to the back plate, the wall extensions 62 of the back plate 22 will align with and snap into the notches 64 of the top plate 24. Top plate 24 includes one or more apertures 40 for entry of one or more screws 42 for securing the top plate 24 to the back plate 22 in order to form an outlet box assembly 44. FIGS. 19 and 20 illustrate the top plate 100 in a two-gang embodiment.

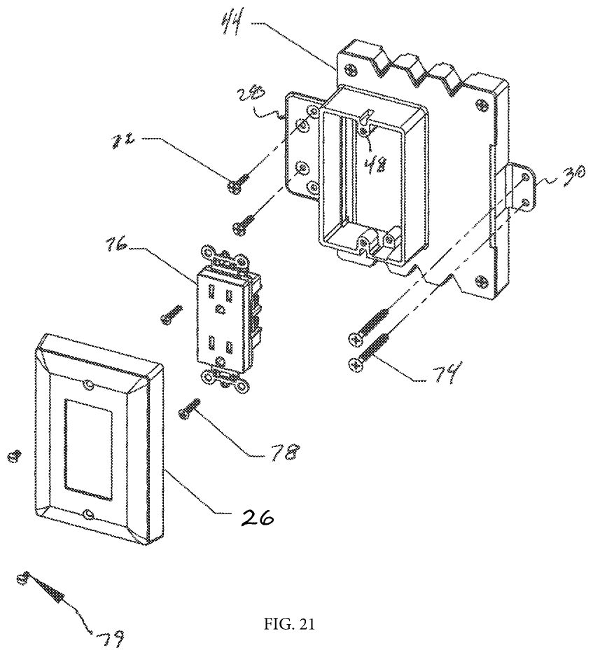

The furred wall box assembly further includes a cover plate 26. As seen in FIGS. 1 and 21, cover plate 26 includes an opening to accommodate an electrical receptacle as well as one or more apertures to accommodate screws (not shown) for securing the cover plate to the box assembly 44. The cover plate can be a conventional cover plate.

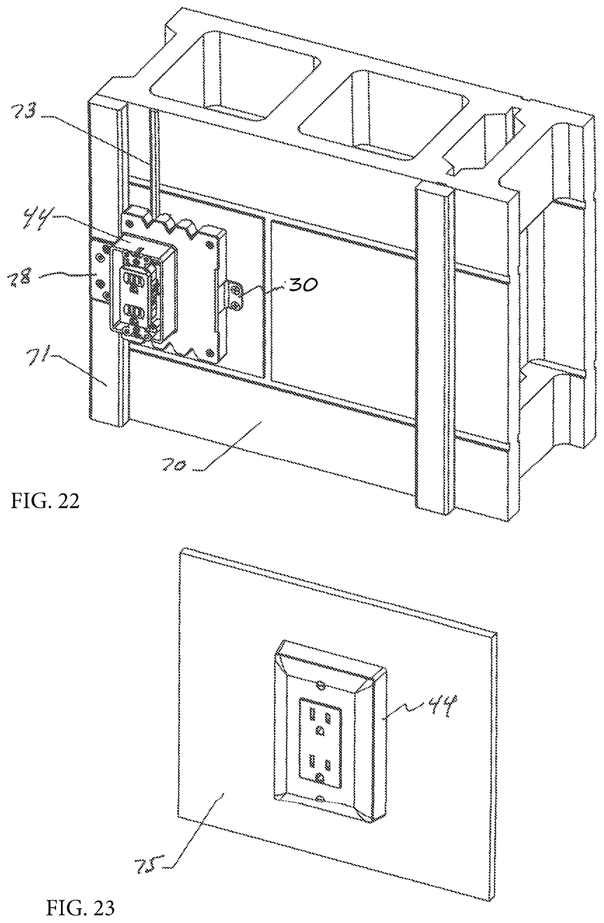

With reference to FIGS. 21-22, either flange can be used to mount either the single-gang or two-gang outlet box assembly to a wall 70. The first flange 28 can be used to mount the box to a furring strip 71, as reflected in FIG. 22, and the second flange 30 can be used to mount the box directly to the wall. Either flange can be used unilaterally or both may be used in unison to secure the box assembly to a wall for added support.

Drywall or similar screws 72 secure the box assembly 44 to the wall through the first flange 28 and masonry or similar screws 74 secure the box assembly to the wall through the second flange 30. After wiring connections to a conventional receptacle 76 are completed the receptacle is secured to the box assembly 44 with receptacle screws 78. A cover plate 26 is then secured to the receptacle 76 and box assembly with cover plate screws 79. The assembly can be used in conjunction with drywall 75 of varying thicknesses.

FIG. 22 depicts the single-gang furred wall box assembly 44 secured to a furring strip 71 on a CMU wall 70. An electrical cable 73 feeds line current through a knockout 38 of the box assembly. with drywall surrounding the mounted box. The cover plate 26 is mounted to the outlet box assembly 44 to complete the installation. FIG. 23 depicts the single-gang furred wall box assembly 44 after drywall is secured to the furring strips of the CMU wall 70 in FIG. 22.

Referring to FIGS. 12-16, as discussed supra, there is shown a second embodiment according to the invention, which is a two-gang furred wall box 80, wherein reference numbers for elements equivalent to those of the first embodiment are numbered alike. The two-gang furred wall box 80 will accommodate mounting of two electrical receptacles or similar electrical devices to a CMU wall. The top plate 24 includes a top wall 46 that provides a greater internal area than that of the first embodiment. Four bosses 48 extend from the inner surface 50 of the top wall 46 for securing two electrical receptacles to the two-gang box assembly 80.

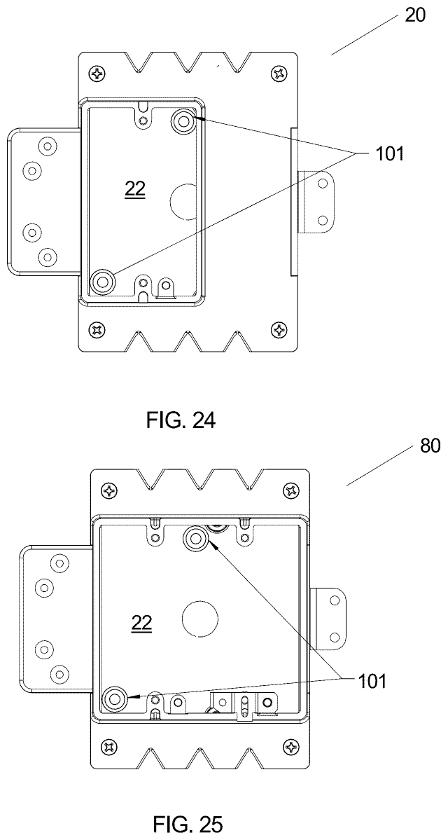

With reference to FIG. 24, alternative element for securing is a front view of the single-gang furred wall box assembly 20 illustrating the use of two ringed bosses 101 added to the back plate 22. The two ringed screw bosses 101 added to the inside of the back plate 22 are provided in case the installer isn't using furring strips and needs an alternative method to secure the box to the block wall using concrete-rated fasteners (not shown), such as TAPCON® metal screw-type masonry fastening anchors, available from Illinois Tool Works, Inc. of Glenview, Illinois, United States.

As shown in FIG. 25, two ringed bosses 101 can also be added to the of the back plate 22 of the two-gang box assembly 80 to secure the box directly to a block wall, without furring strips, using concrete-rated fasteners (not shown).

Conventionally, the installation of an FS box on a concrete wall required the input of additional time and work due to the nature of the mounting material. More specifically, such installations often mandate breaking a portion of the concrete wall in order to create the desired aperture, installing separate furring strips, and/or sealing the intersection of the box and the wall. These additional steps require time and, particularly when magnified by the requirement of multiple box installations, add cost and expense to building construction and improvement. The furred wall box assembly eliminates the need for breaking and resealing CMU walls to install an outlet box.

While the invention has been described in reference to certain preferred embodiments, it will be readily apparent to one of ordinary skill in the art that certain modifications or variations may be made to the device without departing from the scope of invention described in the foregoing specification.

1. An electrical box assembly for mounting electrical components upon a concrete surface comprising:
a back plate; said back plate having a front surface, a rear surface and a base wall extending from said front surface and terminating in an upper planar section;
said base wall on said back plate and extending outwardly from said base wall;
a top plate comprised of a plate surface having a first side and a second side;
said first side of said top plate having an upper wall extending from said first side which defines a cut-out portion of said plate surface;
said upper wall further having an outer surface and an inner surface; and
said top plate further including a plurality of apertures, each aperture being axially aligned with a respective boss from said plurality of bosses on the back plate; at least two mounting bosses located on the inner surface of said upper wall.

2. The electrical box assembly of claim 1 comprising:
said base wall having a first extension extending outwardly from said base wall and a second extension extending outwardly from said base wall;
said first and second extensions being located in parallel on opposite sections of said base wall;
said top plate having a first notch and a second notch along a portion of the perimeter of the plate surface;
said first notch being aligned with said first extension; and
said second notch being aligned with said second extension such that said first notch is disposed to receive said first extension; and said second extension such that said second notch is disposed to receive said second extension.

3. The electrical box assembly of claim 1 comprising:
at least one flange having one or more screw holes therethrough;
said front surface of said back plate including a plurality of bosses having threaded apertures disposed to receive a fastening means; and
at least one knockout aperture in said base wall.

4. The electrical box assembly of claim 3 wherein said at least one flange comprises a flange extending orthogonally from the base wall at a location proximate to said first extension.

5. The electrical box assembly of claim 4 wherein said at least one flange comprises:
a first flange extending orthogonally from the base wall at a location where said base wall intersects with said back plate; and
a second flange extending orthogonally from the base wall at a location proximate to said first extension.

6. The electrical box assembly of claim 1 comprising:
a socket located on said base wall;
an alignment post extending outwardly from the second side of said top plate; and
said alignment post is axially aligned with and mounted in said socket.

7. The electrical box assembly of claim 6 comprising:
said socket comprises at least two sockets and said alignment post comprises at least two alignment posts; and
each of said at least two alignment posts is mounted in one of said at least two sockets.

8. The electrical box assembly of claim 1 wherein said base wall includes a plurality of knockout apertures.

9. The electrical box assembly of claim 1 comprising:
a cover plate;
said cover plate has an open portion within a center area of the cover plate, and
said cover plate includes one or more apertures for the acceptance of fastening means.

10. The electrical box assembly of claim 1 wherein said electrical box assembly is a single-gang electrical box assembly.

11. The electrical box assembly of claim 1 comprising:
said electrical box assembly is a two-gang electrical box assembly, and
said at least two mounting bosses comprises four mounting bosses.

12. The electrical box assembly of claim 1 comprising two ringed bosses on said back plate.
